(19) United States
(12) Patent Application Publication
(10) Pub. No.: US 2009/0295931 A1
(43) Pub. Date: Dec. 3, 2009

(54) DIGITAL PHOTOGRAPHY APPARATUS AND METHOD FOR STORING CONSECUTIVE IMAGES ACCORDING TO A MOTION OF AN OBJECT

(75) Inventor: Deok-eun Cho, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/473,368

(22) Filed: May 28, 2009

(30) Foreign Application Priority Data
May 29, 2008 (KR) 10-2008-0050453

(51) Int. Cl. H04N 5/225

(52) U.S. Cl. 348/220.1; 348/E05.024

(57) ABSTRACT

An embodiment of a digital photography apparatus includes a motion estimation unit configured to estimate an amount of motion of an object and a continuous shooting time interval determination unit configured to determine a continuous shooting time interval between consecutive stored image data frames. The continuous shooting time interval may be based at least in part on the estimated amount of motion of the object. The digital photography apparatus also includes an image capture device configured to generate a plurality of image data frames when the digital photography apparatus is operating in a continuous shooting mode. The plurality of image data frames may be generated at the continuous shooting time interval.

### CROSS-REFERENCE TO RELATED PATENT APPLICATION

This application claims the priority benefit of Korean Patent Application No. 10-2008-0050453, filed on May 29, 2008, in the Korean Intellectual Property Office, which is incorporated herein in its entirety by reference.

### BACKGROUND

1. Field of the Invention

The present invention generally relates to a digital photography apparatus, and more particularly, to a digital photography apparatus and method for storing consecutive images according to a motion of an object.

2. Description of the Related Art

An apparatuses for digital photography (e.g., a digital camera) typically stores still image data or moving picture data (collectively, image data) in a data storage medium. The image data is typically obtained by photography using a single still image shooting mode, a continuous still image shooting mode, or a movie shooting mode of the digital photography apparatus. The digital photography apparatus typically displays a rendition of the image data stored in the data storage medium on a display unit included with the apparatus.

The single still image shooting mode of the digital photography apparatus typically stores image data for a single still image in the data storage medium in response to a single action by the user, such as a press of a shutter button on the digital photography apparatus. The continuous still image shooting mode typically stores image data for multiple consecutive images in response to a single action by the user, such as the press of the shutter button or a press and hold of the shutter button. The image data is typically stored in separate image data files on the data storage medium, one data file per image. The images are typically captured by the digital photography apparatus at a uniform time interval from one another. The time interval is typically set by the user to be a set number of images per second, such as greater than or equal to one, two, five, ten, fifteen, or thirty. The movie shooting mode is typically similar to that described with reference to the continuous still image shooting mode, except that the multiple consecutive images are typically stored in a single image data file such as a movie file on the data storage medium. The movie shooting mode also typically requires two actions by the user to operate, such as one press of the shutter button to begin the movie shooting mode, and one press of the shutter button to end the movie shooting mode.

Because the multiple still images in the continuous shooting mode are typically captured at a uniform time interval from one another, many of the multiple still images stored are typically very similar to one another if a photographed object or the digital photography apparatus moves very little between the capture of the multiple still images. This may result in a waste of limited data storage space and inconvenience a user in selecting a desired still image from among the multiple similar still images.

### SUMMARY

An embodiment of a digital photography apparatus includes a motion estimation unit configured to estimate an amount of motion of an object and a continuous shooting time interval determination unit configured to determine a continuous shooting time interval. The continuous shooting time interval may be based at least in part on the estimated amount of motion of the object. The embodiment of the digital photography apparatus also includes an image capture device configured to generate a plurality of image data frames when the digital photography apparatus is operating in a continuous shooting mode. The plurality of image data frames may be generated at the continuous time interval.

An exemplary method of storing consecutive image data frames captured using a digital photography apparatus includes estimating an amount of motion of an object and determining a continuous shooting time interval between consecutive stored image data frames. The continuous shooting time interval may be based at least in part on the estimated amount of motion of the object. The exemplary method also includes obtaining an image data frame from received light and storing the image data frame. The obtaining and storing steps may be repeated after an amount of time equal to the continuous shooting time interval has elapsed.

A computer-readable storage medium may have stored thereon a program which is executable by a processor to perform a method of storing consecutive image frames captured using a digital photography apparatus. The method may include estimating an amount of motion of an object and determining a continuous shooting time interval between consecutive stored image data frames. The continuous shooting time interval may be based at least in part on the estimated amount of motion of the object. The method may also include obtaining an image data frame from received light and storing the image data frame. The obtaining and storing steps may be repeated after an amount of time equal to the continuous shooting time interval has elapsed.

An embodiment of a digital photography apparatus includes an image capture device configured to generate a plurality of image data frames when the digital photography apparatus is operating in a continuous shooting mode. The plurality of image data frames may be generated at a set continuous shooting time interval. The embodiment of the digital photography apparatus also includes a continuous shooting time interval manipulation unit configured to set the continuous shooting time interval between consecutive stored image data frames. The continuous shooting time interval may be based at least in part on input from a user of the digital photography apparatus. The continuous shooting time interval manipulation unit may be further configured to vary the continuous shooting time interval between the consecutive stored image data frames when the digital photography apparatus is operating in the continuous shooting mode.

### BRIEF DESCRIPTION OF THE DRAWINGS

FIG. 1 is a block diagram of an exemplary digital photography apparatus.

FIGS. 2A and 2B are schematic views of still images of a subject obtained by continuous shooting using a conventional digital photography apparatus when the motion of the subject is small.

FIGS. 3A through 3C are schematic views of exemplary still images of a subject obtained by continuous shooting using the digital photography apparatus of FIG. 1 when the motion of the subject is large.

FIG. 4A is a flowchart of a first exemplary method of controlling a digital photography apparatus.

FIG. 4B is a flowchart of a second exemplary method of controlling a digital photography apparatus.

FIG. 4C is a flowchart of a third exemplary method of controlling a digital photography apparatus.

FIG. 4D is a flowchart of a fourth exemplary method of controlling a digital photography apparatus.

FIG. 5 is a block diagram of another exemplary digital photography apparatus.

### DETAILED DESCRIPTION

In various embodiments, a digital photography apparatus may be configured to reduce undesired storage of multiple similar still images in a continuous shooting mode, such as a high-speed continuous shooting mode of the digital photography apparatus. In accordance with these embodiments, a quantity of continuous images which can be stored and the image resolution in the continuous shooting mode may be less impacted by image processing throughput and data storage limitations of the digital photography apparatus compared to a conventional digital photography apparatus. In addition, a user may not be inconvenienced in selecting a desired still image from among multiple similar still images stored by the digital photography apparatus.

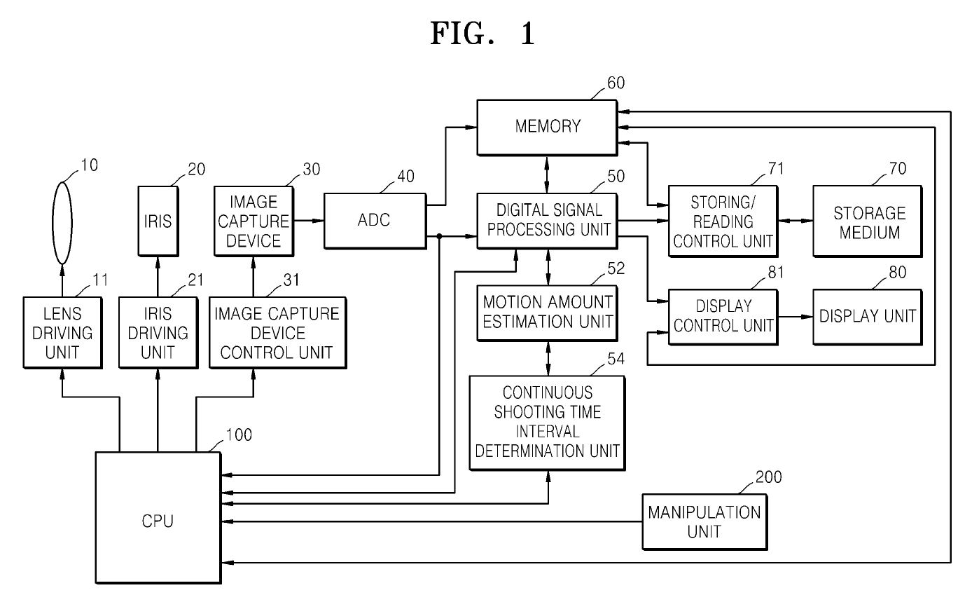

FIG. 1 is a block diagram of an exemplary digital photography apparatus. Substantially all operations of the digital photography apparatus may be controlled by a central processing unit (CPU) 100. The CPU 100 may be configured to control the digital photography apparatus in response to input received from a user. The input from the user may be received via a manipulation unit 200. The manipulation unit 200 may be configured to generate a signal (e.g., an electrical signal) in response to the input from the user and transmit the signal to the CPU 100. The manipulation unit 200 may include a user interface device such as a button, knob, or key which the user manipulates to provide the input to the digital photography apparatus.

The CPU 100 may be configured to provide one or more shooting modes among which the user may select. The CPU 100 may control the digital photography apparatus using a different method depending on the selected shooting mode. When a shooting mode of the CPU 100 is selected, the CPU 100 may analyze an electrical signal generated in response to the user's input and control the digital photography apparatus accordingly. The CPU 100 may control a lens driving unit 11, an iris driving unit 21, and an image capture device control unit 31 in response to the user's input. The lens driving unit 11 may in turn control the position of a lens 10. The iris driving unit 21 may in turn control a degree of openness of an iris 20. The image capture device control unit 31 may in turn control a sensitivity of an image capture device 30. The digital photography apparatus may be configured to receive ambient light through the lens 10 which then focuses the light onto the image capture device 30 after propagating through the iris 20.

The image capture device 30 may generate analog image data representative of an image formed thereon from the received light. An analog-to-digital converter (ADC) 40 may convert the analog image data from the image capture device 30 to digital image data (e.g., an image data frame). In some embodiments, the image capture device 30 may generate the digital image data directly, in which case the digital photography apparatus may not include the ADC 40. The image capture device 30 may generate a plurality of sequential image data frames separated in time by an imaging time interval. In some embodiments, the image capture device 30 may have a fixed imaging time interval. In these embodiments, the digital photography apparatus may store all or optionally less than all of the plurality of sequential image data frames. In other embodiments, the image capture device 30 may be controlled by the image capture device control unit 31 to output image data frames only when controlled to do so.

The digital image data may be provided to a memory 60 and digital signal processing unit 50. The digital image data may be provided to the digital signal processing unit 50 directly or via the memory 60. In some embodiments, the digital image data may also be provided to the CPU 100 directly, via the memory 60, or via the digital signal processing unit 50. The memory 60 may include a read-only memory (ROM), a random access memory (RAM), a dynamic memory, a static memory, or a flash memory. The digital signal processing unit 50 may be configured to perform digital signal processing, such as gamma correction, white balance correction, and other image processing functions as may be desired.

The digital signal processing unit 50 may output the digital image data to a display control unit 81 directly or via the memory 60. The display control unit 81 may control a display unit 80 to display a rendition of the digital image data on the display unit 80. The display unit 80 may include a liquid crystal display (LCD) integrated with the digital photography apparatus, a video monitor external to the digital photography apparatus, or other units capable of displaying an image.

The digital signal processing unit 50 may also output the digital image data to a storing/reading control unit 71 directly or via the memory 60. The storing/reading control unit 71 may store the digital image data in a storage medium 70 in response to an input received from the user, in response to a command from the digital signal processing unit 50 or CPU 100, or automatically upon receiving the digital image data. The storage medium 70 may include memory implemented in an integrated circuit (e.g., random access memory (RAM), read-only memory (ROM), erasable programmable read only memory (EPROM), static RAM (SRAM), or flash memory), a magnetic storage medium (e.g., floppy disk, or hard disk), or an optical storage medium (e.g., compact disc (CD or CD-ROM) or digital versatile disc (DVD or DVD-ROM)). The storage medium 70 may be attachable to and detachable from the digital photography apparatus. Alternatively, the storage medium 70 may be permanently built into the digital photography apparatus.

The storing/reading controller 71 may also read the digital image data stored in the storage medium 70 and provide the read digital image data to the display control unit 81 via the memory 60, the digital signal processing unit 50, or via another path such that a rendition of the read digital image data is displayed on the display unit 80. The storing/reading controller 71 may also provide the read digital image data to the digital signal processing unit 50 or the CPU 100 for image processing and/or editing operations as may be desired by the user.

The digital signal processing unit 50 may output the digital image data to a motion amount estimation unit 52. The motion amount estimation unit 52 may estimate an amount of motion of an object. The object may include a subject which reflects incident light which is then received through the lens 10, focused on the image capture device 30, and then imaged by the image capture device 30. The object may also include the digital photography apparatus itself. For example, the motion of the digital photography apparatus may manifest itself in apparent motion of the subject being imaged by the digital photography apparatus.

The digital image data may also be provided to a continuous shooting time interval determination unit 54 either via the motion amount estimation unit 52 or directly from the digital signal processing unit 50. The continuous shooting time interval determination unit 54 may determine a continuous shooting time interval between consecutive stored image data frames. The continuous shooting time interval may be used to set a time interval between successive image data frames captured by the image capture device 30, stored in the memory 60, and/or stored in the storage medium 70. The continuous shooting time interval may be based at least in part on the estimated amount of motion determined by the motion amount estimation unit 52.

In some embodiments, the continuous shooting time interval is based at least in part on the estimated amount of motion determined by the motion amount estimation unit 52 exceeding a threshold amount of motion. For example, the motion amount estimation unit 52 may compare one image data frame previously stored in the memory 60 or the storage medium 70 with the digital image data currently provided to the motion amount estimation unit 52. Based on the comparison, an amount of motion may be estimated using a method of image processing or analysis. In other embodiments, the continuous shooting time interval may be based at least in part on the estimated amount of motion determined by the motion amount estimation unit 52 using other methods.

In some embodiments, the continuous shooting time interval may be based at least in part on a user's input. In these embodiments, the user may select the continuous shooting time interval directly before taking photographs using the continuous shooting mode. The user may also change or select the continuous shooting time interval directly while taking photographs using the continuous shooting mode. The user may alternatively adjust a sensitivity to motion or the threshold amount of motion to be used by the continuous shooting time interval determination unit 54 in determining the continuous shooting time interval. The user may perform this adjustment before or while taking photographs using the continuous shooting mode.

Although the motion amount determination unit 52 and the continuous shooting time interval determination unit 54 are illustrated as separate elements from the digital signal processing unit 50, the motion amount determination unit 52 and the continuous shooting time interval determination unit 54 may be constructed in various forms. For example, one or both of these two units may be included in the digital signal processing unit 50. Alternatively, one or both of these two units may be included in another element, such as the CPU 100.

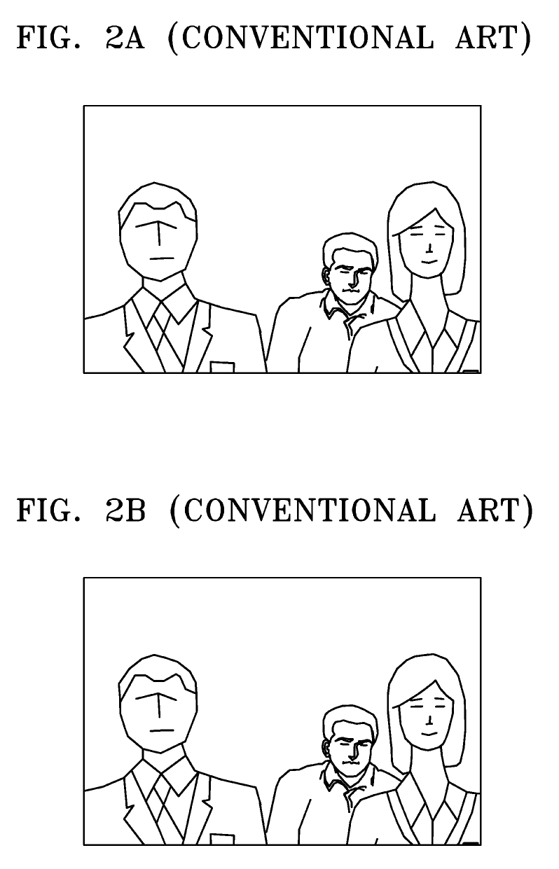

FIGS. 2A and 2B are schematic views of still images of a subject obtained by continuous shooting using a conventional digital photography apparatus when the motion of the subject is small. When a subject such as a human figure, a group of people, an inanimate object, and/or a landscape moves very little, most image data frames obtained in a high-speed continuous shooting mode of the digital photography apparatus may be very similar. Having numerous very similar image data files associated with the similar image data frames stored in the storage medium 70 may waste limited data storage resources as well as complicate a user's selection of a desired image among the multiple similar still images to view or edit.

However, embodiments of the digital photography apparatus as described herein may obtain multiple image data frames at optimal time intervals between each other in a continuous shooting mode by adjusting the time interval. The time interval may be optimized such that only multiple image data frames are stored when each of the multiple image data frames differs from the other multiple image data frames appreciably. The image data frames may be determined to differ from one another appreciably based on an image processing method which determines an amount of motion of a subject between the multiple image data frames or other measure of similarity between the images as may be understood by those with skill in the art of image processing and compression. For example, if one image data frame would not be visibly distinct from another image data frame when viewed by an ordinary user, the image data frames may be determined to not differ appreciably.

In an exemplary embodiment, once the motion amount estimation unit 52 has estimated the amount of motion of the object, the continuous shooting time interval determination unit 54 may determine a continuous shooting time interval based on the estimated amount of motion of the object. The image capture device 30 may obtain successive still image data frames at a time interval approximately equal to the continuous shooting time interval determined by the continuous shooting time interval determination unit 54. Each of the obtained successive still image data frames may then be stored in the storage medium 70. Alternatively, the image capture device 30 may obtain successive image data frames at a time interval less than the continuous shooting time interval determined by the continuous shooting time interval determination unit 54, but only those obtained successive image data frames which are captured after an elapsed time approximately equal to the continuous shooting time interval since a previously stored image data frame may then be stored in the storage medium 70.

For example, when a subject photographed in a continuous shooting mode has little motion as illustrated in FIGS. 2A and 2B, the motion amount estimation unit 52 may determine that the amount of motion of the object is small. The continuous shooting time interval determination unit 54 may then determine the continuous shooting time interval to be longer than a default or user-input time interval based on the determination of the motion amount estimation unit 52. Due to the longer continuous shooting time interval, embodiments of the digital photography apparatus as described herein may avoid storing multiple similar still image data frames, as illustrated in FIGS. 2A and 2B, in the continuous shooting mode. Accordingly, the user may find viewing, editing, and/or organizing the stored still image data frames later on to be more convenient than with conventional digital photography apparatuses. In addition, waste of the limited storage capacity of the storage medium 70 may be prevented by embodiments of the digital photography apparatus as described herein.

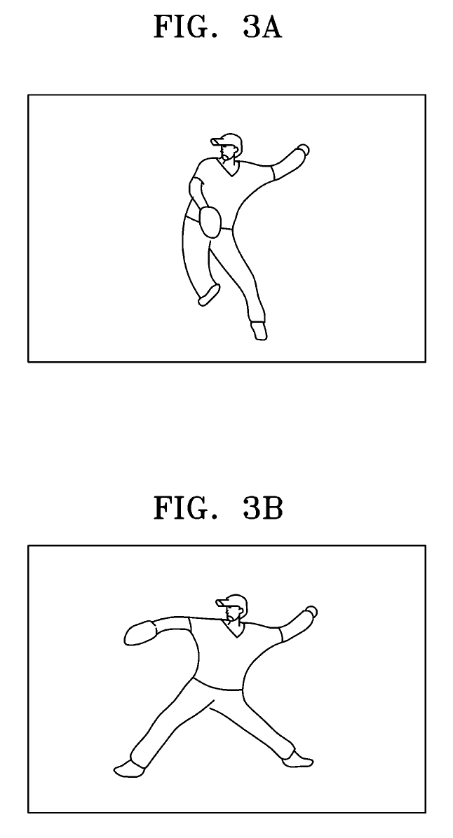

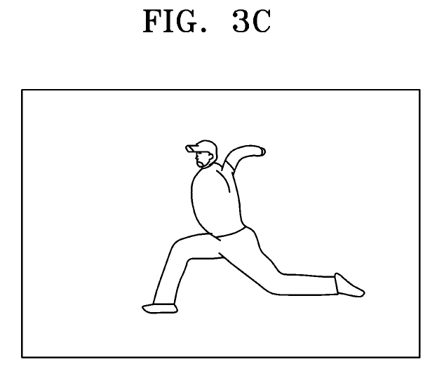

FIGS. 3A through 3C are schematic views of exemplary still images of a subject obtained by continuous shooting using the digital photography apparatus of FIG. 1 when the motion of the subject is large. When an embodiment of the digital photography apparatus as described herein is used to obtain still images of a subject that moves fast (e.g., an athlete practicing a sport, a car being driven, and/or a running animal), the motion amount estimation unit 52 may determine that the amount of motion of the subject is large. The continuous shooting time interval determination unit 54 may then determine the continuous shooting time interval to be shorter than the default or the user-input time interval based on the determination of the motion amount estimation unit 52. Since this results in the time interval between stored image data frames of the subject according to the continuous shooting time interval being short in the continuous shooting mode, successive still images of the fast-moving subject may be effectively obtained by the digital photography apparatus as illustrated in FIGS. 3A through 3C.

In the embodiments described above with reference to FIGS. 2A and 2B and FIGS. 3A through 3C, adjustments of the continuous shooting time interval are based at least in part on the amount of motion of the subject. However, embodiments of the digital photography apparatus described herein may adjust the continuous shooting time interval based at least in part on other factors. For example, even when the digital photography apparatus obtains still image data frames of a subject that moves little, as illustrated in FIGS. 2A and 2B, when a motion of the digital photography apparatus is large, successive still image data frames which differ appreciably from one another may be obtained in a continuous shooting mode. Therefore, in some embodiments, the motion amount estimation unit 52 may estimate the amount of motion of the digital photography apparatus rather than the subject. Accordingly, the continuous shooting time interval determination unit 54 may determine the continuous shooting time interval based at least in part on the estimated amount of motion of the digital photography apparatus.

The motion amount estimation unit 52 may use any of a variety of methods to estimate the amount of motion. For example, prior to beginning photographing in the continuous shooting mode, a live view or real-time moving picture of the subject may be obtained by the digital photography apparatus. The real-time moving picture may be displayed on the display unit 80. The real-time moving picture may also be analyzed by the motion amount estimation unit 52 to estimate the amount of motion of the subject and/or the digital photography apparatus. For example, consecutive image data frames of the real-time moving picture or image data frames separated by specific time intervals may be compared to determine the amount of motion of the subject. In this way, the continuous shooting time interval may be determined before the digital photography apparatus is operated in the continuous shooting mode or the digital photography apparatus has started the continuous shooting process.

As another example, a moving picture shooting function of the digital photography apparatus may be utilized to estimate the amount of motion of the subject. In embodiments of this example, the digital photography apparatus may further include an image encoder (not shown) configured to compress moving picture image data frames to effectively and efficiently store the sequence of image data frames, for example as a movie file. The encoder may determine a degree of similarity among the image data frames of the moving picture and accordingly reduce a total size of the moving picture image data. An amount of motion of the subject and/or the digital photography apparatus may be estimated by analyzing differences in position of the subject in the image data frames of the moving picture or the degree of similarity among the image data frames.

Alternatively, the digital photography apparatus may further include a motion sensor (not shown). Examples of motion sensors include a gyroscope (i.e., gyro sensor) and an accelerometer. In some embodiments, the motion sensor may include a micro-electro-mechanical system (MEMS) device. The motion amount estimation unit 52 may estimate the amount of motion of the digital photography apparatus using the motion sensor, for example by analyzing input to the motion amount estimation unit 52 received from the motion sensor. The motion sensor may be included in the digital photography apparatus in connection with anti-shake or image stabilization functionality, and the motion sensor may be additionally used by the motion amount estimation unit 52 without requiring an additional element be included in the digital photography apparatus to provide the motion sensing functionality.

In some embodiments, the continuous shooting time interval determination unit 54 may determine the continuous shooting time interval during operation of the digital photography apparatus in the continuous shooting mode or during the continuous shooting process. For example, once multiple image data frames have been obtained in the continuous shooting process, the continuous shooting time interval determination unit 54 may repeatedly update the continuous shooting time interval. The updates to the continuous shooting time interval may be based on user input (such as manipulating a knob, dial, or button) during the continuous shooting process, or based on analysis of the image data frames obtained and/or stored during the continuous shooting process. The motion amount estimation unit 52 may repeatedly estimate the amount of motion of the subject and/or the digital photography apparatus and provide the repeated estimations to the continuous shooting time interval determination unit 54 during the continuous shooting process. In these embodiments, even when the continuous shooting time interval is initially set to be long because the amount of motion of the subject and/or the digital photography apparatus is small before the start of the continuous shooting process, the continuous shooting time interval may be adjusted to be shorter during the continuous shooting process so that image data frames at short time intervals may be obtained if the amount of motion increases.

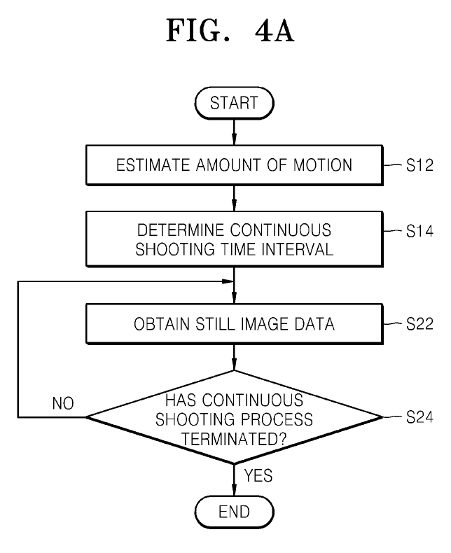

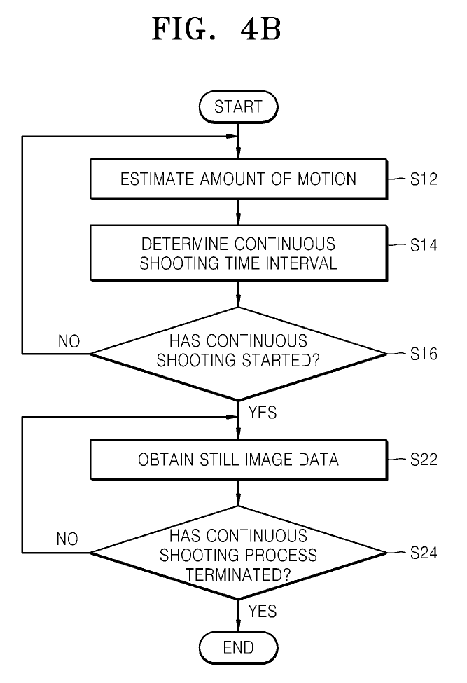

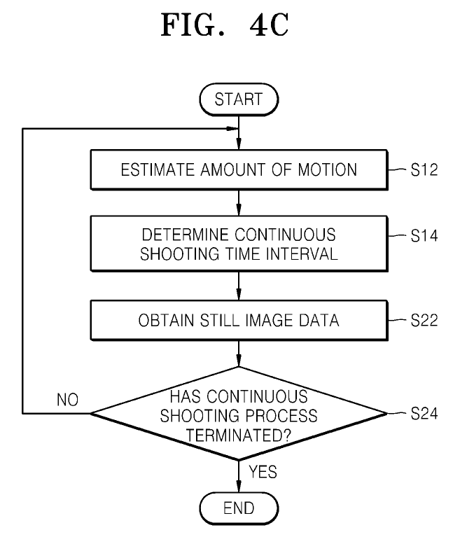

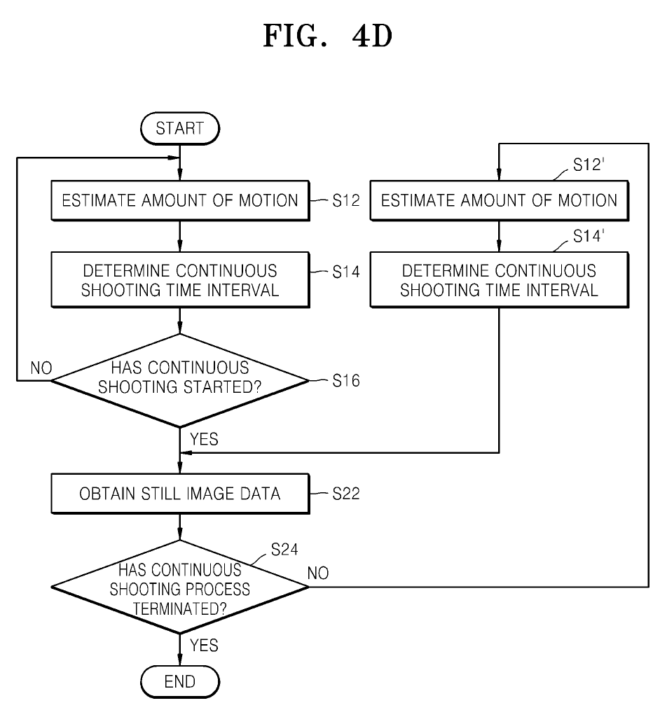

FIG. 4A is a flowchart of a first exemplary method of controlling a digital photography apparatus, such as the exemplary digital photography apparatus illustrated in FIG. 1. “START” may indicate either the beginning of a continuous shooting mode of the digital photography apparatus, or the beginning of a continuous shooting process using the digital photography apparatus. “END” may indicate the termination of the continuous shooting process.

The exemplary method includes estimating the amount of motion of the subject and/or digital photography apparatus in a step S12 and determining a continuous shooting time interval based at least in part on the estimated amount of motion in a step S14. Steps S12 and S14 may collectively be included in a continuous shooting speed determination process and referred to as such. Still image data may then be obtained in a step S22. Step S22 may begin as a user activates the manipulation unit 200, for example by pressing a shutter button. The still image data obtained in step S22 may be obtained by the image capture device 30 as an image data frame. Obtaining the still image data in step S22 may include storing the still image data, for example in the memory 60 or the storage medium 70.

After the still image data is obtained, a determination may be made, for example by the CPU 100, as to whether the continuous shooting process has terminated in a step S24. If the continuous shooting process is determined to not be terminated, still image data is obtained again in step S22. New still image data may be obtained in the current iteration through step S22 after an elapsed time approximately equal to the continuous shooting time interval since a point of time at which the preceding still image data is obtained.

After step S22 in which the still image data is obtained again, the step S24 is performed again to determine whether the continuous shooting process has terminated. For example, the continuous shooting process may be determined to be terminated when the user is no longer pressing the shutter button. Alternatively, the continuous shooting process may be determined to be terminated when maximum storage capacity for the still image data (e.g., the storage medium 70 or the memory 60) has been reached. Steps S22 and S24 may be included collectively in a continuous shooting process and referred to as such.

In the exemplary method illustrated in FIG. 4A, the continuous shooting time interval may be adjusted based on the amount of motion of the subject and/or the digital photography apparatus. As a result, a quantity of multiple similar still images obtained in the continuous shooting process may be reduced compared to a method of continuous shooting employed in a conventional digital photography apparatus. In addition, when the motion of the subject and/or the digital photography apparatus is large, multiple still images having a short continuous shooting time interval therebetween may be obtained.

FIG. 4B is a flowchart of a second exemplary method of controlling a digital photography apparatus. “START” may indicate the beginning of the continuous shooting mode of the digital photography apparatus. “END” may indicate the termination of the continuous shooting process. When the continuous shooting mode starts, the amount of motion of the subject and/or the digital photography apparatus is estimated in a step S12, the continuous shooting time interval is determined in a step S14, and a determination is made as to whether continuous shooting has started in a step S16. If the determination is made that continuous shooting has not started, step S12 is performed again to estimate the amount of motion of the subject and/or the digital photography apparatus and the continuous shooting time interval is determined again in step S14. Accordingly, information regarding the continuous shooting time interval may be continuously updated before continuous shooting starts. Alternatively, if the determination is made in step S16 that continuous shooting has started, then steps S22 and S24 may be performed as described above with reference to FIG. 4A.

In the exemplary methods of controlling a digital photography apparatus described with reference to FIGS. 4A and 4B, the continuous shooting speed determination process terminates before the continuous shooting process starts. Once the continuous shooting process has started, the continuous shooting time interval may be maintained constant. In other exemplary methods, the continuous shooting time interval may be varied once the continuous shooting process has started.

FIG. 4C is a flowchart of a third exemplary method of controlling a digital photography apparatus. “START” may indicate the beginning of a continuous shooting process, and “END” may indicate the termination of the continuous shooting process. When the continuous shooting process starts, an amount of motion of the subject and/or the digital photography apparatus may be estimated in a step S12. The continuous shooting time interval may be determined in a step S14. Still image data may be obtained in a step S22. The still image data obtained in step S22 may be obtained by the image capture device 30 as an image data frame. Obtaining the still image data may include storing the still image data, for example in the memory 60 or the storage medium 70.

A determination may be made in a step S24 as to whether the continuous shooting process has terminated. If the continuous shooting process is determined to not be terminated, steps S12 and S14 may be performed again to update information regarding the continuous shooting time interval. Then, step S22 may be performed again to obtain additional still image data at a time interval in accordance with the updated continuous shooting time interval.

FIG. 4D is a flowchart of a fourth exemplary method of controlling a digital photography apparatus. “START” may indicate the beginning of a continuous shooting mode, and “END” may indicate the termination of a continuous shooting process. An amount of motion of the subject and/or the digital photography apparatus may be estimated in a step S12. A continuous shooting time interval may be determined in a step S14. A determination may be made as to whether the continuous shooting process has started in step S16. If the continuous shooting process has not started, step S12 of estimating the amount of motion of the subject and/or the digital photography apparatus and step S14 of determining the continuous shooting time interval may be performed again such that information regarding the continuous shooting time interval may be continuously updated before continuous shooting starts. If the determination is made that the continuous shooting process has started, still image data may be obtained in step S22. The still image data obtained in step S22 may be obtained by the image capture device 30 as an image data frame. Obtaining the still image data may include storing the still image data, for example in the memory 60 or the storage medium 70.

In step S24, a determination may be made as to whether the continuous shooting process has terminated. If a determination is made in step S24 that the continuous shooting process has not terminated, a continuous shooting speed determination process including a step S12′ of estimating the amount of motion of the subject and/or the digital photography apparatus and a step S14′ of determining (e.g., updating) the continuous shooting time interval may be performed. Thereafter, step S22 may be performed again in which additional still image data may be obtained using a time interval in accordance with the updated continuous shooting time interval determined in step S14′. In the exemplary method illustrated in FIG. 4D, the continuous shooting speed determination process may be performed both before the continuous shooting time process begins (including steps S12 and S14), as well as after the continuous shooting time process begins and throughout the continuous shooting time process (including steps S12′ and S14′).

The amount of motion of the subject and/or the digital photography apparatus may be estimated using the methods described with reference to FIGS. 4A through 4D above in connection with the digital photography apparatus of FIG. 1. In the case where the digital photography apparatus includes a motion sensor, the amount of motion of the digital photography apparatus may be estimated using the motion sensor.

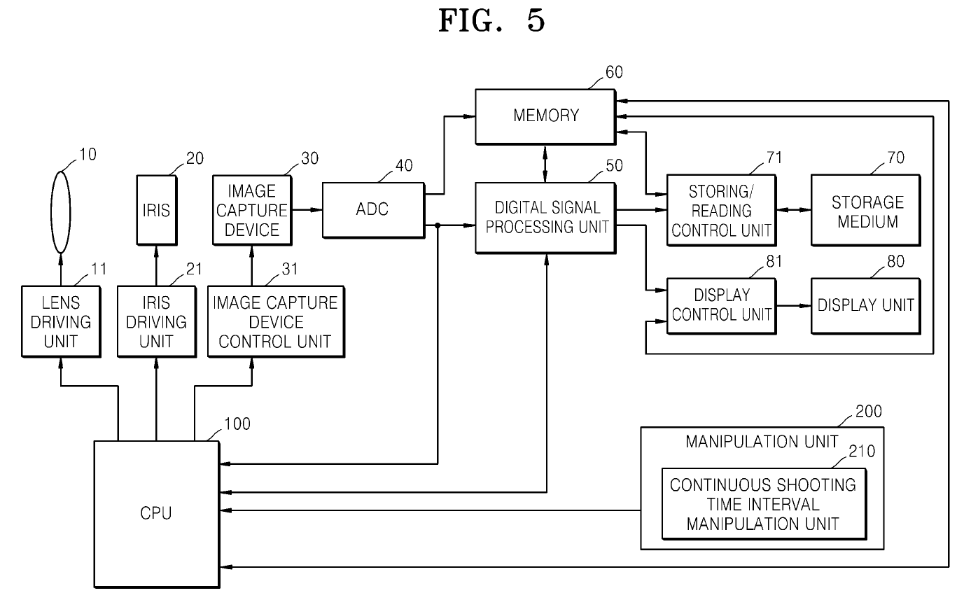

FIG. 5 is a block diagram of another exemplary digital photography apparatus. In contrast with the digital photography apparatus described above with reference to FIG. 1, the manipulation unit 200 of the exemplary digital photography apparatus illustrated in FIG. 5 includes a continuous shooting time interval manipulation unit 210, and the exemplary digital photography apparatus illustrated in FIG. 5 does not include the motion amount estimation unit 52 and the continuous shooting time interval determination unit 54. The continuous shooting time interval manipulation unit 210 may set the continuous shooting time interval according to manipulations by the user, for example according to a turn of a knob, a manipulation of a dial, a press of a button, or a selection of a value among a plurality of values using a user interface. As a result, the image data may be obtained by the image capture device 30 according to the continuous shooting time interval set by the continuous shooting time interval manipulation unit 210.

The continuous shooting time interval manipulation unit 210 may set the continuous shooting time interval before continuous shooting begins, according to the manipulations by the user. Accordingly, the digital photography apparatus may obtain image data frames at a constant set continuous shooting time interval during continuous shooting. Alternatively, the continuous shooting time interval manipulation unit 210 may set the continuous shooting time interval during continuous shooting, according to the manipulations by the user. Accordingly, the digital photography apparatus may obtain image data frames at continuous shooting time intervals that vary during continuous shooting. In this way, a continuous shooting speed which corresponds with the user's intentions may be performed, whether the continuous shooting speed is constant or varies throughout the continuous shooting process.

The exemplary digital photography apparatus illustrated in FIG. 5 may be used to perform continuous shooting by obtaining still image data, determining whether the continuous shooting process has terminated, and when the continuous shooting process is determined not to have terminated, obtaining additional still image data after a time approximately equal to a continuous shooting time interval set by the user elapses from a point of time at which the previous still image data has been obtained. Thereafter, a determination as to whether the continuous shooting process has terminated may again be made. The process described above may be repeated until the continuous shooting process is determined to have terminated. The user of the exemplary digital photography apparatus illustrated in FIG. 5 may set the continuous shooting time interval before the continuous shooting process starts such that the continuous shooting time interval may be maintained constant during continuous shooting. The user may also set the continuous shooting time interval during the continuous shooting process, such that the continuous shooting time interval may vary during continuous shooting.

In various embodiments, a further exemplary digital photography apparatus may combine features of the exemplary digital photography apparatus as described with reference to FIG. 1 and the exemplary digital photography apparatus as described with reference to FIG. 5. In particular, the further exemplary digital photography apparatus may be configured to set the continuous shooting time interval using a combination of any or all of the motion amount estimation unit 52, the continuous shooting time interval determination unit 54, and the continuous shooting time interval manipulation unit 210.

A program for executing a method of controlling a digital photography apparatus as described herein may be stored in a computer readable storage medium. The program may include instructions executable by a processor such as the CPU 100 or the digital signal processing unit 50. The computer readable storage medium may include the storage medium 70 or the memory 60 illustrated in FIG. 1 and FIG. 5. The computer readable storage medium may include memory implemented in an integrated circuit (e.g., random access memory (RAM), read-only memory (ROM), erasable programmable read only memory (EPROM), static RAM (SRAM), or flash memory), a magnetic storage medium (e.g., floppy disk or hard disk), or an optical storage medium (e.g., compact disc (CD or CD-ROM) or digital versatile disc (DVD or DVD-ROM)).

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated. It will be recognized that the terms “comprising,” “including,” and “having,” as used herein, are specifically intended to be read as open-ended terms of art.

What is claimed is:

1. A digital photography apparatus comprising:
a motion estimation unit configured to estimate an amount of motion of an object;
a continuous shooting time interval determination unit configured to determine a continuous shooting time interval based at least in part on the estimated amount of motion of the object; and
an image capture device configured to generate a plurality of image data frames when the digital photography apparatus is operating in a continuous shooting mode, the plurality of image data frames being generated at the continuous shooting time interval.

2. The digital photography apparatus of claim 1, wherein the continuous shooting time interval determination unit is further configured to determine the continuous shooting time interval before the digital photography apparatus is performing a continuous shooting process.

3. The digital photography apparatus of claim 1, wherein the motion estimation unit is further configured to repeatedly estimate the amount of motion of the object when the digital photography apparatus is performing a continuous shooting process, and the continuous shooting time interval determination unit is further configured to repeatedly update the continuous shooting time interval when the digital photography apparatus is performing the continuous shooting process, the updating of the continuous shooting time interval based at least in part on the repeatedly estimated amount of motion of the object.

4. The digital photography apparatus of claim 1, wherein the object includes a subject which reflects incident light subsequently received by the digital photography apparatus and imaged by the image capture device.

5. The digital photography apparatus of claim 1, wherein the object includes the digital photography apparatus.

6. The digital photography apparatus of claim 1, wherein the estimated amount of motion of the object is determined at least in part by analyzing at least two image data frames.

7. The digital photography apparatus of claim 1, wherein the estimated amount of motion of the object is determined at least in part by a motion sensor.

8. The digital photography apparatus of claim 7, wherein the motion sensor includes a gyroscope or an accelerometer.

9. The digital photography apparatus of claim 1, wherein the continuous shooting time interval is further based at least in part on the estimated amount of motion of the object exceeding a threshold amount of motion.

10. A method of storing consecutive image data frames captured using a digital photography apparatus, the method comprising:
estimating an amount of motion of an object;
determining a continuous shooting time interval between consecutive stored image data frames, the continuous shooting time interval based at least in part on the estimated amount of motion of the object;
obtaining an image data frame from received light;
storing the image data frame; and
repeating the obtaining and storing steps after an amount of time equal to the continuous shooting time interval has elapsed.

11. The method of claim 10, wherein estimating the amount of motion of the object includes comparing the obtained image data frame with a prior stored image data frame.

12. The method of claim 10, wherein estimating the amount of motion of the object includes analyzing input from a motion sensor.

13. The method of claim 10, wherein the continuous shooting time interval is further based at least in part on the estimated amount of motion of the object exceeding a threshold amount of motion.

14. The method of claim 10, wherein repeating the obtaining and storing steps further comprises repeating the estimating and the determining steps to update the continuous shooting time interval.

15. A computer-readable storage medium having stored thereon a program, the program executable by a processor to perform a method of storing consecutive image frames captured using a digital photography apparatus, the method comprising:
estimating an amount of motion of an object;
determining a continuous shooting time interval between consecutive stored image data frames, the continuous shooting time interval based at least in part on the estimated amount of motion of the object;
obtaining an image data frame from received light;
storing the image data frame; and
repeating the obtaining and storing steps after an amount of time equal to the continuous shooting time interval has elapsed.

16. The computer-readable storage medium of claim 15, wherein estimating the amount of motion of the object includes comparing the obtained image data frame with a prior stored image data frame.

17. The computer-readable storage medium of claim 15, wherein estimating the amount of motion of the object includes analyzing input from a motion sensor.

18. The computer-readable storage medium of claim 15, wherein the continuous shooting time interval is further based at least in part on the estimated amount of motion of the object exceeding a threshold amount of motion.

19. The computer-readable storage medium of claim 15, wherein repeating the obtaining and storing steps further comprises repeating the estimating and the determining steps to update the continuous shooting time interval.

20. A digital photography apparatus comprising:
an image capture device configured to generate a plurality of image data frames when the digital photography apparatus is operating in a continuous shooting mode, the plurality of image data frames being generated at a set continuous shooting time interval; and
a continuous shooting time interval manipulation unit configured to set the continuous shooting time interval between consecutive stored image data frames, the continuous shooting time interval based at least in part on input from a user of the digital photography apparatus, the continuous shooting time interval manipulation unit further configured to vary the continuous shooting time interval between the consecutive stored image data frames when the digital photography apparatus is operating in the continuous shooting mode.

21. A method of storing consecutive image data frames captured using a digital photography apparatus, the method comprising:
obtaining an image data frame from received light;
storing the image data frame; and
repeating the obtaining and storing steps after an amount of time equal to a continuous shooting time interval has elapsed,
wherein the continuous shooting time interval is changed based at least in part on input from a user of the digital photography apparatus during the digital photography apparatus is operating in a continuous shooting mode.
